(19) United States
(12) Patent Application Publication
(10) Pub. No.: US 2010/0232515 A1
(43) Pub. Date: Sep. 16, 2010

(54) Decoding Device and Method Thereof

(75) Inventor: Chuan-Chang Hsu, Hsinchu Hsien (TW)

Correspondence Address: LEE & HAYES, PLLC, 601 W. RIVERSIDE AVENUE, SUITE 1400, SPOKANE, WA, 99201, US

(73) Assignee: MStar Semiconductor, Inc., Hsinchu Hsien (TW)

(21) Appl. No.: 12/724,144

(22) Filed: Mar. 15, 2010

(30) Foreign Application Priority Data
Mar. 16, 2009 (TW) 098108363

(51) Int. Cl. H04J 3/24

(52) U.S. Cl. 375/240.25; 375/E07.027

(57) ABSTRACT

A decoding device and its associated decoding method are disclosed. In one aspect, the decoding device can be used for processing a first packet unit and a consecutive second packet unit, and includes a bit stream feeder, a decoder, and a determining circuit. The bit stream feeder provides the first packet unit and the second packet unit, and determines a boundary of the first packet unit to transmit a first boundary informing signal. The decoder decodes the first packet unit and the second packet unit, and determines the boundary of the first packet unit to transmit a second boundary informing signal. The determining circuit generates a determination result signal according to the first boundary informing signal and the second boundary informing signal. The decoder and the bit stream feeder operates according to the determination result signal so that the second packet unit is successfully decoded when the first packet unit cannot be successfully decoded.

### CROSS REFERENCE TO RELATED PATENT APPLICATIONS

This patent application claims priority from Taiwan Patent Application No. 098108363, filed in the Taiwan Patent Office on Mar. 16, 2009, entitled “Decoding Device and Method Thereof”, and incorporates the Taiwan patent application in its entirety by reference.

### TECHNICAL FIELD

The present disclosure relates to a decoding device and a method thereof, and more particularly, to a decoding device capable of processing and decoding numerous packet units and a method thereof.

### BACKGROUND OF THE DISCLOSURE

H.264 is a digital video encoding standard developed by a joint video team comprising the Video Coding Experts Group (VCEG) of the International Telecommunication Union-Telecommunication Standardization Sector (ITU-T) and the Moving Picture Experts Group (MPEG) of the International Organization for Standardization/the International Electro-technical Commission (ISO/IEC). The H.264 algorithm is divided into two conceptual layers—a video coding layer (VCL) for efficiently expressing video content, and a network abstraction layer (NAL) for formatting a data encoded by the VCL and providing header information in an appropriate approach to networks or storages mediums in order to perform data transmission. FIG. 1 shows a structural schematic diagram of a video signal. In the H.264 specification, an NAL unit serves as a packet unit, and image data of a video signal Sin is stored in numerous NAL units. Referring to FIG. 1, the video signal Sin comprises three packet units marked as NAL0, NAL1, and NAL2. Each of packet units (e.g., an NAL unit) comprises a header 101 and a payload 102. The header 101 provides header information of the NAL unit, e.g., a start code prefix, a file type, and an index. The payload 102 comprises numerous encoded syntax data Stx0 to StxN.

For example, when a display device of a digital television decodes the received video signal Sin with a decoder, image data segments of the video signal Sin may be erroneously transmitted to incur a situation that the display device cannot successfully decode or display the video signal Sin.

### SUMMARY OF THE DISCLOSURE

In view of the foregoing problem, one object of the present disclosure is to provide a decoding device and a method thereof, which are capable of reducing possibilities that the decoding device fail to successfully decode encoded data that is erroneously transmitted. In an embodiment, the decoding device and the method thereof are applied to an image processing device and an associated method to reduce possibilities that the decoding device fail to successfully decode a video signal Sin resulted from the image data segments of the video signal Sin being erroneously transmitted.

According to an embodiment of the present disclosure, a decoding device, for processing a first packet unit and a consecutive second packet unit, comprises a bit stream feeder, a decoder, and a determining circuit. The bit stream feeder provides the first packet unit and the second packet unit, and determines a boundary of the first packet unit to transmit a first boundary informing signal. The decoder, coupled to the bit stream feeder, decodes the first packet unit and the second packet unit, and determines the boundary of the first packet unit to transmit a second boundary informing signal. The determining circuit, coupled to the bit stream feeder and the decoder, receives the first boundary informing signal and the second boundary informing signal, and generates a determination result signal according to the first boundary informing signal and the second boundary informing signal. The decoder and the bit stream feeder operate according to the determination result signal, so as to successfully decode the second packet unit when the first packet unit can not be successfully decoded.

According to another embodiment, a decoding method, for processing a first packet unit and a consecutive second packet unit, comprises providing the first packet unit and the second packet unit and determining a boundary of the first packet unit to transmit a first boundary informing signal; decoding the first packet unit and determining the boundary of the first packet unit to transmit a second boundary informing signal; generating a determination result signal according to the first boundary informing signal and the second boundary informing signal; and operating according to the determination result signal, so as to successfully decode the second packet unit when the first packet unit cannot be successfully decoded.

The advantages and spirit related to the present disclosure can be further understood via the following detailed description and drawings.

### BRIEF DESCRIPTION OF THE DRAWINGS

FIG. 1 is a structural schematic diagram of a video signal.

FIG. 2 is a block diagram of a decoding device coupled to a dynamic random access memory (DRAM) in accordance with an embodiment of the present disclosure.

FIG. 3 is a structural schematic diagram of an encoded data.

FIG. 4 is a schematic diagram of an example of an error occurring during decoding of a decoding device in accordance with an embodiment of the present disclosure.

FIG. 5 is a schematic diagram of an example of an error occurring during decoding of a decoding device in accordance with an embodiment of the present disclosure.

FIG. 6 is a block diagram of a decoding device in accordance with an embodiment of the present disclosure.

FIG. 7 is a schematic diagram of an example of a decoding device preventing generating decoding errors in accordance with an embodiment of the present disclosure.

FIG. 8 is a schematic diagram of an example of a decoding device preventing generating decoding errors in accordance with an embodiment of the present disclosure.

FIG. 9 is a flow chart is a decoding method in accordance with an embodiment of the present disclosure.

### DETAILED DESCRIPTION OF THE PREFERRED EMBODIMENT

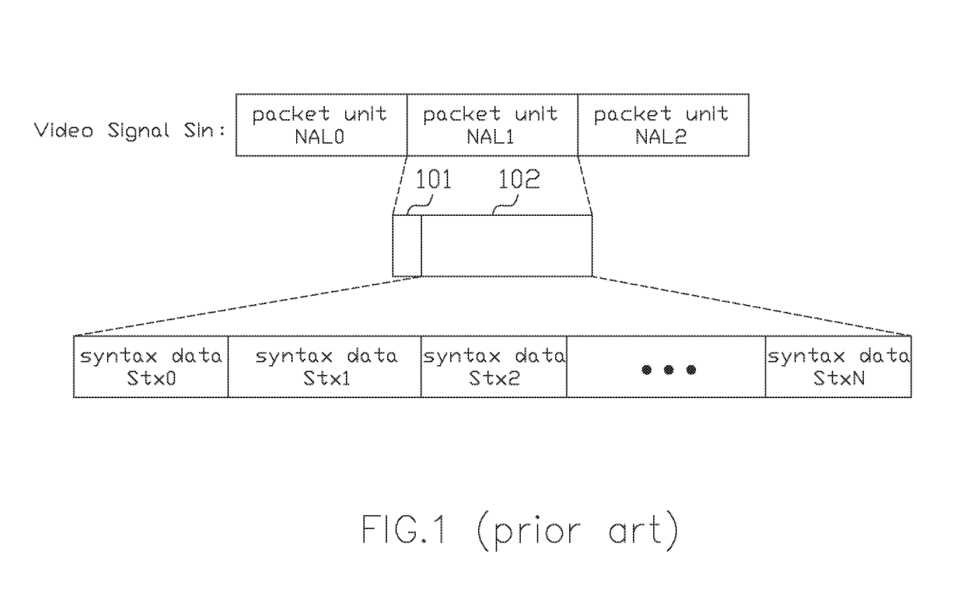

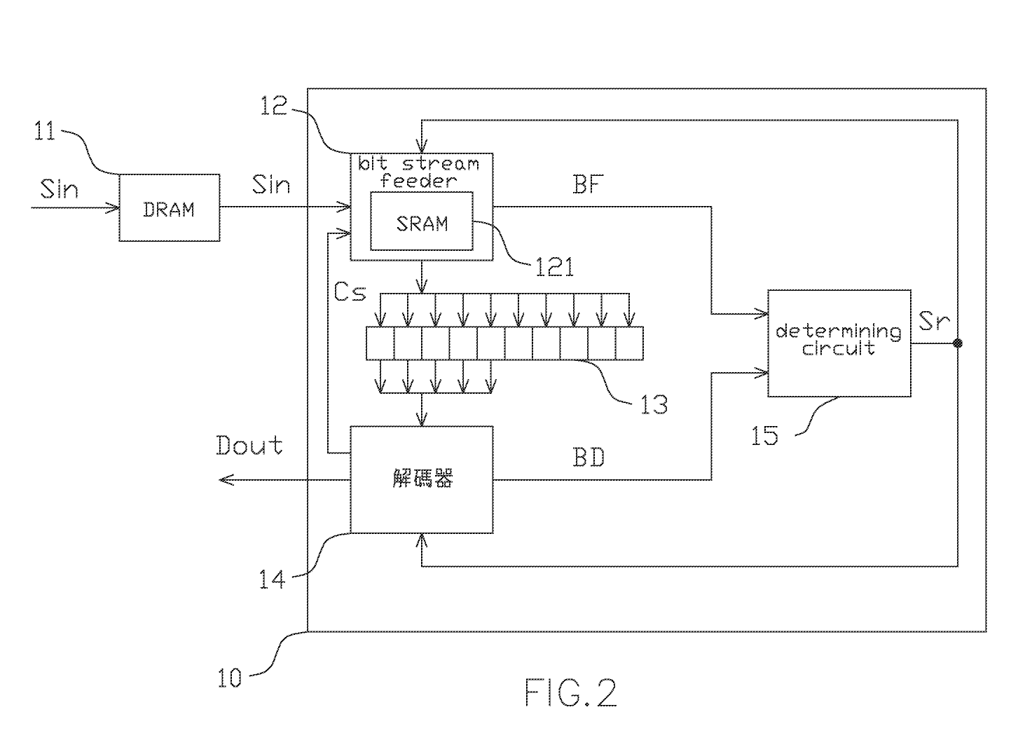

FIG. 2 shows a block diagram of a decoding device coupled to a dynamic random access memory (RAM) in accordance with an embodiment of the present disclosure. In this embodiment, a decoding device 10, for processing video signals, is built in a display device comprising a DRAM 11 to process a video signal Sin received by the display device. For example, the video signal Sin is an encoded data illustrated in FIG. 1. The decoding device 10, coupled to the DRAM 11, comprises a bit stream feeder 12, a decoder 14, and a determining circuit 15 coupled to the bit stream feeder 12 and the decoder 14. The bit steam feeder 12 comprises a static random access memory (SRAM) 121. The DRAM 11 receives from an input end (not shown) the video signal Sin, which is a bit stream (BS), for example. When the decoding device 10 operates, the bit stream feeder 12 receives the video signal Sin from the DRAM 11 and temporarily stores the video signal Sin into the SRAM 121. The bit stream feeder 12 in sequence provides a plurality of bit data Bits of the video signal Sin to the decoder 14. In this embodiment, the decoding device 10 further comprises a shifter 13 coupled between the bit stream feeder 12 and the decoder 14. The bit stream feeder 12 in sequence provides the plurality of bit data Bits of the video signal Sin to the shifter 13. The decoder 14 retrieves and decodes bn-bit data from the shifter 13 according to syntax data of a current packet, and informs the bit stream feeder 12 to retrieve the bn-bit data via a control signal CS (not shown). After that, the bit stream feeder 12 deletes the front bn-bit data stored in the shifter 13 according to the number of bn-bit data contained in the control signal CS, shifts unprocessed consecutive bit data forward to the forefront of the shifter 13, and feeds bit data received from the SRAM 121 to the back end of the shifter 13.

When data of the video signal Sin is transmitted, image data segments of the video signal Sin may be erroneously transmitted to incur a situation that the decoding device fail to successfully decode the video signal Sin, and one reason for the occurrence is described below.

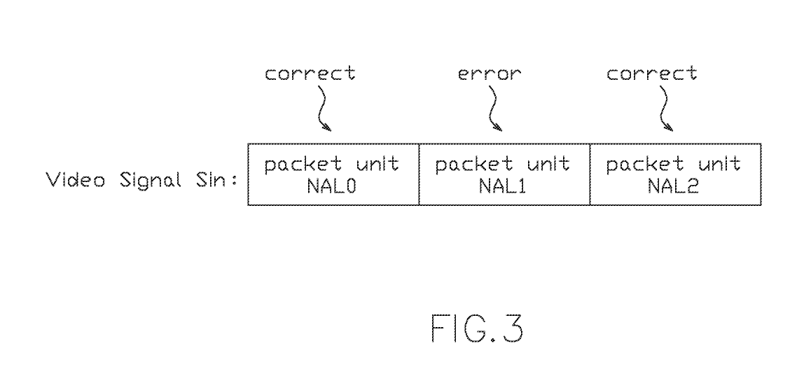

In a packet unit, e.g., an NAL unit, bit lengths of numerous syntax data determined in an image encoding process are different from each other, and thus bit lengths of the packets units can be different. FIG. 3 shows a structural schematic diagram of an encoded data. In this embodiment, the encoded data is an image data. For example, an original packet unit NAL1 has a bit length of 80, which is determined according to content of the image data. When the packet unit NAL1 is erroneously transmitted, i.e., when content of syntax data of the packet unit NAL1 comprises errors, the decoder 14 may use a bit length that is not equal to 80 to decode the packet unit NAL1, such that an a packet unit NAL2 previously error-free cannot be successfully decoded due to an erroneous start point. Moreover, transmission errors of the packet unit NAL1 may incur decoding errors in subsequent packet units to result in error propagation, to an extent that the display device fails to successfully decode or display the video signal Sin.

Referring to FIG. 2, in this embodiment, when the bit stream feeder 12 provides bit data of a syntax data of the packet unit NAL1 to the decoder 14, it further determines a boundary of the packet unit NAL1, i.e., an end point of the packet unit NAL1 or a start point of the packet unit NAL2, to transmit a boundary informing signal BF to the determining circuit 15. The decoder 14 decodes the packet unit NAL1, and further determines the boundary of the packet unit NAL1 to transmit another boundary informing signal BD to the determining circuit 15. The determining circuit 15 generates a determination result signal Sr according to the boundary informing signal BF and the boundary informing signal BD. The bit stream feeder 12 and/or the decoder 14 selectively performs an alternative step, also known as an abnormal step, according to the determination result signal Sr so that the decoder 14 can successfully decodes the packet unit NAL2 according to bit data of the packet unit NAL2.

In this embodiment, the boundary informing signal BF and the boundary informing signal BD is logical 1 or logical 0. Logical 1 means that the bit stream feeder 12 and the decoder 14 respectively find the boundary of the packet unit NAL1, and logical 0 means that the stream feeder 12 and the decoder 14 do not find any boundary. When the determining circuit 15 determines that logical values of the boundary informing signal BF and the boundary informing signal BD are both logical 1 or both logical 0, the determination result signal Sr in logical 1 is generated. When the determining circuit 15 determines one of the boundary informing signal BF and the boundary informing signal BD is logical 1 and the other one is not logical 1, the determination result signal Sr in logical 0 is generated. Only when the other boundary informing signal is also detected as logical 1, the determining circuit 15 generates the determination result signal Sr in logical 1. The determination result signal Sr in logical 1 means that the bit stream feeder 12 and the decoder 14 process a same current packet unit (i.e., the bit stream feeder 12 and the decoder 14 are synchronized); more specifically, it means that neither the bit stream feeder 12 nor the decoder 14 finds any boundary of the packet unit NAL1, or the bit stream feeder 12 and the decoder 14 both find the boundary of the packet unit NAL1. The determination result signal Sr in logical 0 represents a situation opposite to the foregoing description to represent an abnormal situation.

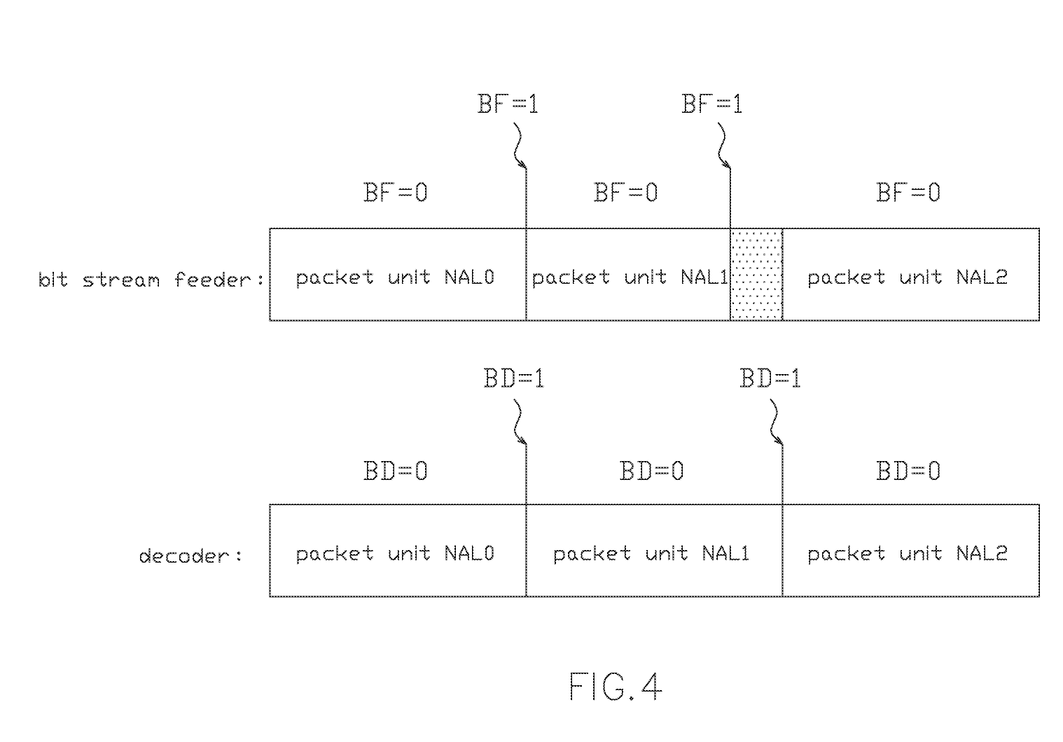

Refer to FIG. 4 showing a schematic diagram of an error occurring during decoding of a decoding device. As shown, the bit stream feeder 12 finds a boundary of the packet unit NAL1 before the decoder 14 does. When the bit stream feeder 12 determines the boundary of the packet unit NAL1 and receives the determination result signal Sr in logical 0, it means that the bit stream feeder 12 finds the boundary of the packet unit NAL1 before the decoder 14 does. At this point, when the decoder 14 requests for bit data, the bit stream feeder 12 first provides at least a dummy bit, and only provides the bit data of the packet unit NAL2 when the determination result signal Sr indicates that the decoder 14 finds the boundary of the packet unit NAL1.

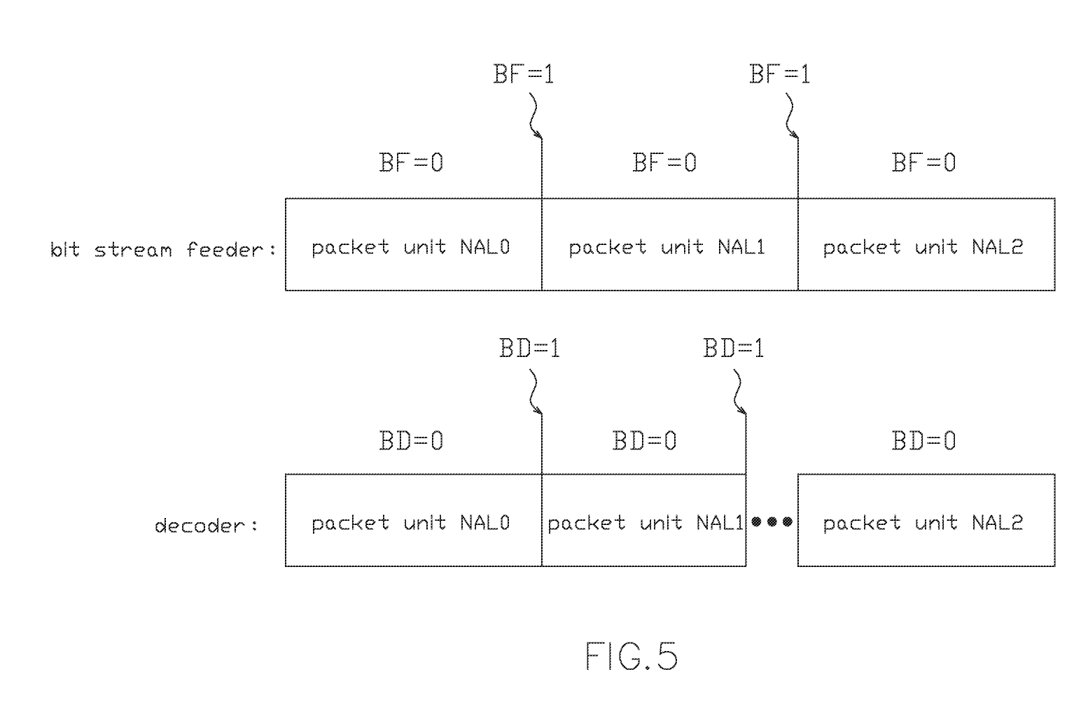

Refer to FIG. 5 showing a schematic diagram of an error occurring during decoding of a decoding device. As shown, the decoder 14 finds a boundary of the packet unit NAL1 before the bit stream feeder 12 does. When the decoder 14 determines the boundary of the packet unit NAL1 and receives the determination result signal Sr in logical 0, it means that the decoder 14 finds the boundary of the packet unit NAL1 before the bit stream feeder 12 does, and thus the decoder 14 does not use bit data of the packet unit NAL1 provided by the bit stream feeder 12. In this embodiment, a part of the bit data provided by the bit steam feeder 12 is discarded, and the decoder 14 only begins to receive bit data of the packet unit NAL2 provided by the bit stream feeder 12 when the determination result signal Sr indicates that the bit stream feeder 12 finds the boundary of the packet unit NAL1.

In this embodiment, the method for determining the boundary of the packet unit NAL1 by the bit stream feeder 12 and the decoder 14 is not limited, and a method for finding the boundary of the packet unit NAL1 is described below for illustrative purposes. According to the H.264 specification, the back end of a packet unit NAL is composed of 24 consecutive logical-0 bits counting from a byte-aligned address of bit groups, and the NAL packet unit comprises a start code prefix, e.g., 0x000001, recorded in a header of the NAL packet unit. Accordingly, the bit stream feeder 12 or the decoder 14 determines a boundary of a packet unit according to either the bit data of the packet unit NAL1 or the bit data of the packet unit NAL2. In particular, the bit stream feeder 12 checks whether a pattern of three consecutive logical 0 exists in the processed data, and the back end of the packet unit NAL1 is determined when the answer is positive. Otherwise, the bit stream feeder 12 checks whether the start code prefix is present in the processed data to determine the front end of the packet unit NAL2. Therefore, the boundary joining the packet unit NAL1 and the packet unit NAL2 is determined. In addition, the decoder 14 can determine the boundary of the packet unit NAL1 according to syntax data of the packet unit NAL1. For example, when the decoder 14 decodes syntax data needed in the packet unit NAL1 according to a predetermined algorithm, the back end of the packet unit NAL1 is determined. Alternatively, certain predetermined flags in the syntax data of the packet unit NAL1 are identified to determine the back end of the packet unit NAL1.

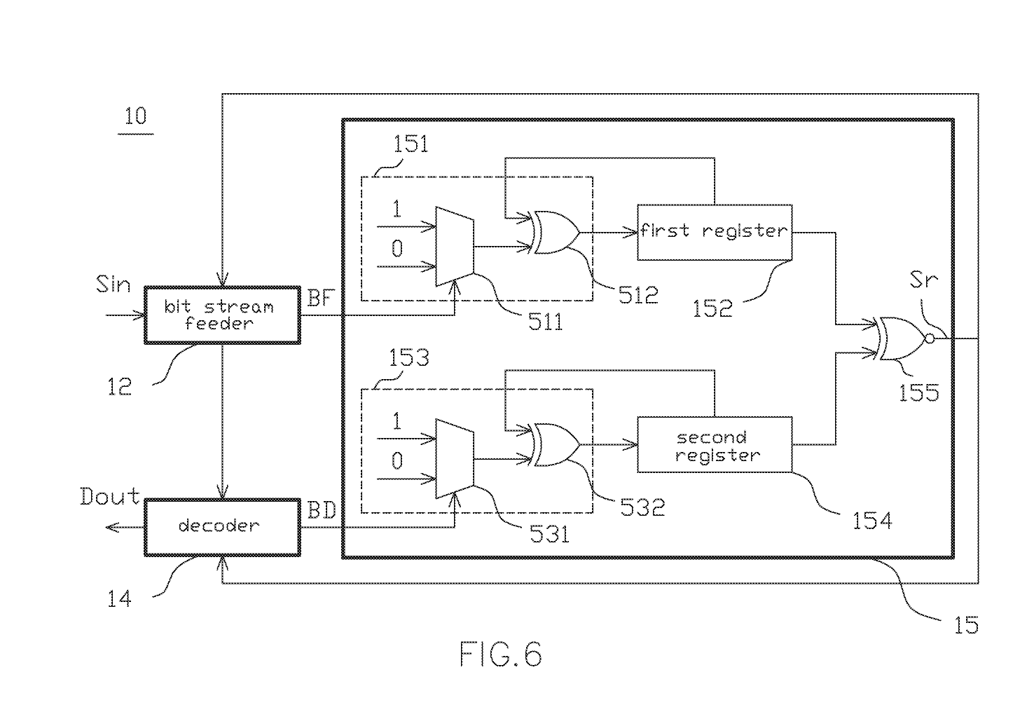

FIG. 6 is a block diagram of a decoding device in accordance with an embodiment of the present disclosure. Since FIG. 6 is the detailed structure of the decoding device illustrated in FIG. 2, same symbols are denoted for the same components and associated description is not disclosed for brevity. In order to determine the boundary of the packet unit NAL1 by the bit stream feeder 12 and the decoder 14, and to determine whether the bit stream feeder 12 and the decoder 14 process a same current packet unit, in this embodiment, the decoding device 10 further provides a parity characteristic to each of the packet units of the video signal Sin. Preferably, parities of adjacent packet units comprise different logical values, e.g., logical values of parities of the packet units NAL0, NAL1 and NAL2 are respectively 0, 1 and 0. In addition, the decoding device in this embodiment is realized by hardware, with associated description to be disclosed below.

An example of the determining circuit 15 in this embodiment is described in detail below. Referring to FIG. 6, the determining circuit 15 comprises a first logic unit 151, a second logic unit 153, a first register 152, a second register 154, and a third logic unit 155. The first register 152 is stored with a parity (i.e., a first parity ParityFD) of a current packet unit processed by the bit stream feeder 12, and the second register 154 is stored with a parity (i.e., a second parity ParityDEC) of a current packet unit processed by the decoder 14. The first logic unit 151 receives a boundary informing signal BF provided by the bit stream feeder 12 and the first parity ParityFD stored in the first register 152, and selectively alters a logical value of the first parity ParityFD according to the boundary informing signal BF and the logical value of the first parity ParityFD to prompt processing of a next packet unit. The second logic unit 153 receives the boundary informing signal BD from the decoder 14 and the second parity ParityDEC stored in the second register 154, and selectively alters a logical value of the second parity ParityDEC according to the boundary informing signal BD and the logical value of the second parity ParityDEC to prompt processing of a next packet unit.

In particular, the first logic unit 151 comprises a first multiplexer 511 and a first XOR gate 512. The first multiplexer 511 comprises an input end for inputting logical 1 and another input end for inputting logical 0, and selectively outputs an output signal Smux1 having a logical value of 1 or 0. When the boundary informing signal BF is logical 1, the first multiplexer 511 outputs the output signal Smux1 in logical 1; when the boundary informing signal BF is logical 0,the first multiplexer 511 outputs the output signal Smux1 in logical 0. The first XOR gate 512 receives the first parity ParityFD and the output signal Sumx1. When the output signal Smux1 and the first parity ParityFD have a same logical value, the first XOR gate 512 outputs logical 0 to be stored in the first register 152 such that the first parity ParityFD is logical 0. When the output signal Smux1 and the first parity have different logical values, the first XOR gate 512 outputs logical 1 to be stored in the first register 152 such that the first parity ParityFD is logical 1. Accordingly, when the bit stream feeder 12 does not detect the boundary of the current packet unit, the logical value of the parity ParityFD remains unchanged. When the boundary of the current packet unit are crossed, the logical value of the parity ParityFD is first inversed and remains unchanged until a boundary of a next packet unit is again reached. Therefore, the third logic unit 155 obtains the parity of the current packet unit processed by the bit stream feeder 12 according to the logical value of the first parity ParityFD stored in the first register 152.

In this embodiment, the second logic unit 153 comprises a second multiplexer 531 and a second XOR gate 532. An operation approach of the second logic unit 153 is the same as that of the first logic unit 151, and detailed description thereof shall not be described for brevity. Accordingly, the third logic unit 155 obtains the parity of the current packet unit processed by the decoder 14 according to the logical value of the second parity ParityDEC stored in the second register 154.

The third logic unit 155 determines whether the parities of the current packet units respectively processed by the bit stream feeder 12 and the decoder 14 are the same, and generates a determination result signal Sr. In this embodiment, the third logic unit 155 may be an XNOR gate for receiving the first parity ParityFD and the second ParityDEC. When the first parity ParityFD and the second parity ParityDEC are in a same logical value, the third logic unit 155 outputs the determination result signal Sr in logical 1, meaning that the bit steam feeder 12 and the decoder are synchronized; when the first parity ParityFD and the second parity ParityDEC are in different logical values, the third logic unit 155 outputs the determination result signal Sr in logical 0, meaning that the bit stream feeder 12 and the decoder 14 are unsynchronized.

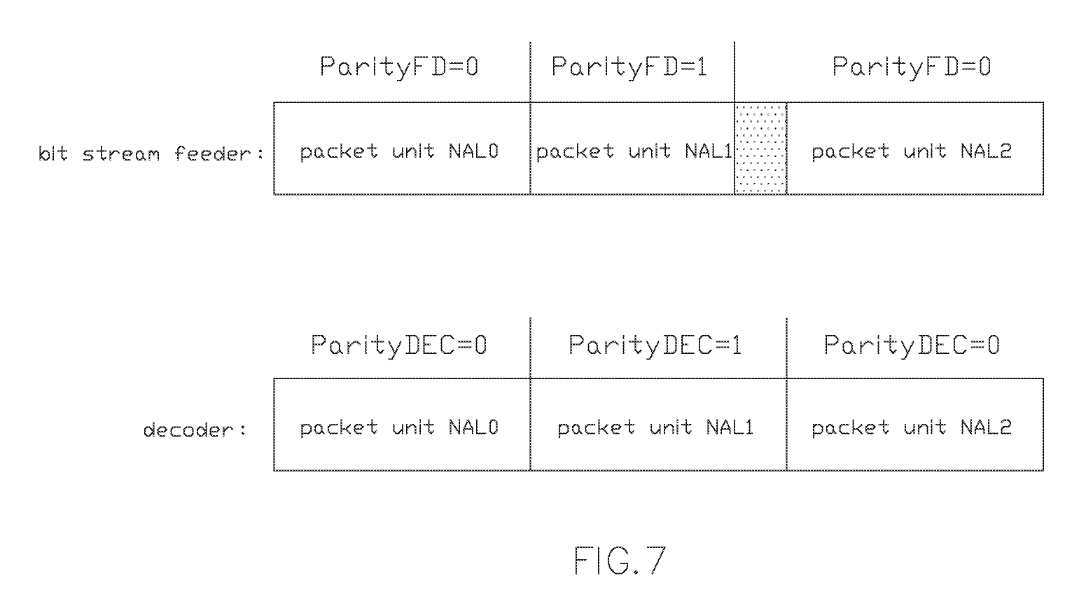

Refer to FIG. 7 showing a schematic diagram of a decoding device preventing decoding errors in accordance with an embodiment of the present disclosure. As shown, the bit stream feeder 12 finds the boundary of the packet unit NAL1 before the decoder 14 does. When the bit steam feeder 12 finds the boundary of the packet unit NAL1 and receives the determination result signal Sr in logical 0, it means that the bit steam feeder 12 finds the boundary of the packet unit NAL1 before the decoder 14 does. At this point, when the decoder 14 requests for bit data, the bit stream feeder 12 first provides at least a dummy bit, and then only provides bit data of the packet unit NAL2 when the determination result signal Sr in logical 1 is received.

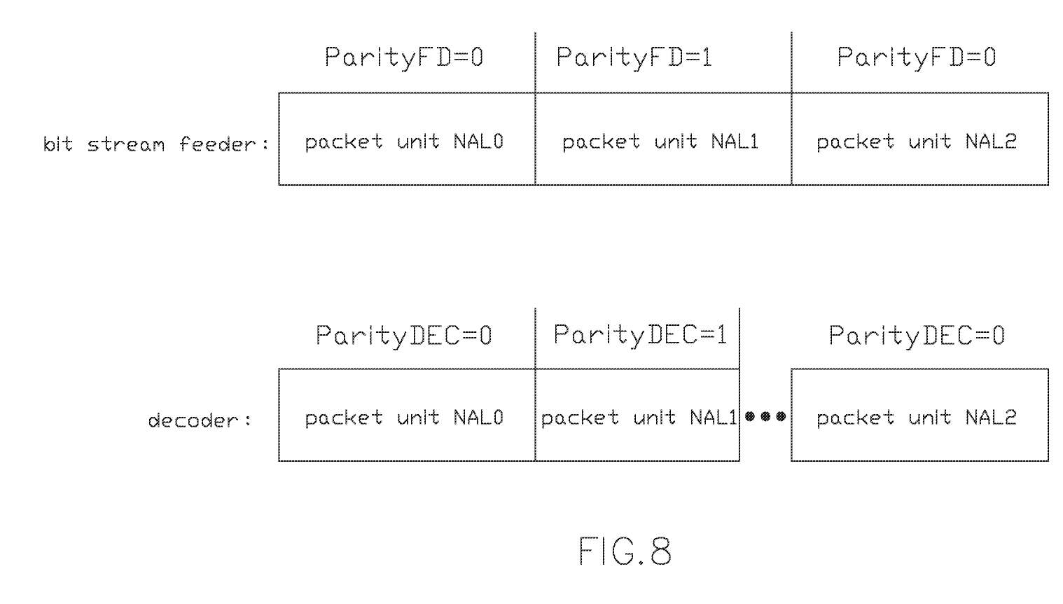

Refer to FIG. 8 showing a schematic diagram of a decoding device preventing decoding errors in accordance with an embodiment of the present disclosure. As shown, the decoder 14 finds the boundary of the packet unit NAL1 before the bit stream feeder 12 does. When the decoder finds the boundary of the packet unit NAL1 and receives the determination result signal Sr in logical 0, it means that the decoder 14 finds the boundary of the packet unit NAL1 before the bit stream feeder 12 does. At this point, the decoder 14 discards a part of data provided by the bit steam feeder 12, and begins to receive bit data of the packet unit NAL2 provided by the bit stream feeder 12 when the determination result signal Sr in logical 1 is received.

In this embodiment, the bit stream feeder 12 and/or the decoder 14 selectively performs an alternative step, also known as an abnormal step, according to the determination result signal Sr, such that the decoder 14 can successfully decode the packet unit NAL2 according to the bit data of the packet unit NAL2; however, the operation approaches of the bit stream feeder 12 and the decoder 14 of the present disclosure are not limited to the foregoing embodiment. In another embodiment, when the bit stream feeder 12 and the decoder 14 respectively find the boundary of the packet unit NAL1 and receive the determination result signal Sr in logical 0, the processing on the packet unit NAL1 is stopped and the packet unit NAL2 is directly processed instead.

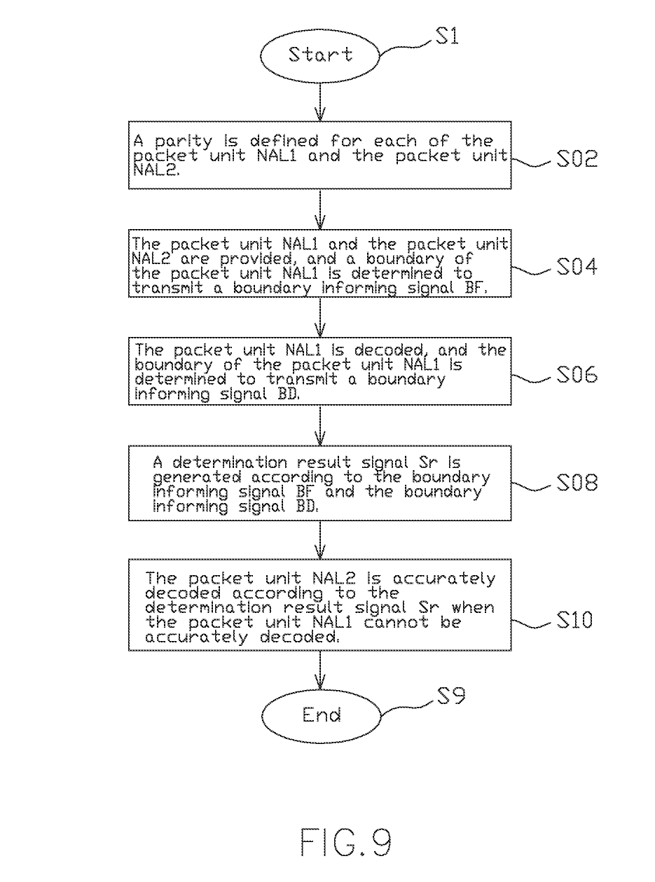

Refer to FIG. 9 showing a flow chart of a decoding method in accordance with an embodiment of the present disclosure. In this embodiment, the decoding method is for processing a video signal Sin comprising a packet unit NAL1 and a consecutive packet unit NAL2, which respectively comprise a plurality of bit data. The decoding method comprises steps below.

In Step S02, a parity is defined for each of the packet unit NAL1 and the packet unit NAL2, and a logic value of the parity of the packet unit NAL1 is different from that of the packet unit NAL2. In an embodiment, Step S02 comprises defining a parity for the packet unit NAL2 and defining a parity for the packet unit NAL1.

In Step S04, the packet unit NAL1 and the packet unit NAL2 are provided, and a boundary of the packet unit NAL1 is determined to transmit a boundary informing signal BF. In an embodiment, the packet unit NAL2 is continuously provided after the packet unit NAL1 is provided.

In Step S06, the packet unit NAL1 is decoded, and the boundary of the packet unit NAL1 is determined to transmit a boundary informing signal BD.

In Step S08, a determination result signal Sr is generated according to the boundary informing signal BF and the boundary informing signal BD. In an embodiment, when the boundary informing signal BF is transmitted in Step S04, a current packet unit processed in Step S04 is changed from the packet unit NAL1 to the packet unit NAL2; when the boundary informing signal BD is transmitted in Step S06, the current packet unit processed in Step S04 is changed from the packet unit NAL1 to the packet unit NAL2. Since the logical value of the parity of the packet unit NAL1 is different from that of the packet unit NAL2, the determination result signal Sr is generated in Step S08 according to whether the logical value of the parity of the current packet unit processed in Step S04 is the same as that of the current packet unit processed in Step S06. When the determination result is positive, the determination result signal Sr in logical 1 is generated, meaning that Step S04 and Step S06 are synchronized; when the determination result is negative, the determination result signal Sr in logical 0 is generated, meaning that Step S04 and Step S06 are unsynchronized. It is to be noted that, Step S06 need not be performed after Step S04 is completely performed, and Step S04 and Step S06 may be simultaneously performed during a certain period.

In Step S10, the packet unit NAL2 is successfully decoded according to the determination result signal Sr when the packet unit NAL1 cannot be successfully decoded. For example, under certain circumstances, according to the determination result signal Sr, when the boundary of the packet unit NAL1 is determined in Step S04 earlier than that in Step S06 while bit data to be decoded is requested in Step S06, at least one dummy bit is first provided in Step S10 until the determination result signal Sr indicates the synchronization. In another situation, according to the determination result signal Sr, when the boundary of the packet unit NAL1 is determined in Step S06 earlier than that in Step S04, the bit data of the packet unit NAL1 provided in Step S04 is first discarded, and is only received in Step S06 when the determination result signal Sr indicates the synchronization. In the foregoing two examples, the packet unit NAL2 still can be successfully decoded even when the packet unit NAL1 cannot be successfully decoded.

In the foregoing embodiments, a decoding device applied to video processing is described for illustration purposes; however, the decoding device and a method thereof provided by the present disclosure, not limited to applications of image processing, are capable of decoding any encoded data.

According to embodiments of the present disclosure, a decoding device and a method thereof are capable of reducing possibilities that the decoding device fail to successfully decode encoded data that is erroneously transmitted. In an embodiment, the decoding device and the method thereof process an encoded image signal to avoid a phenomenon that a display device fails to display a video signal Sin resulted from the image data segments of the video signal Sin being erroneously transmitted.

While the embodiments have been described in terms of what is presently considered to be the most practical and preferred embodiments, it is to be understood that the embodiments need not to be limited to those described above. On the contrary, it is intended to cover various modifications and similar arrangements included within the spirit and scope of the appended claims which are to be accorded with the broadest interpretation so as to encompass all such modifications and similar structures.

What is claimed is:

1. A decoding device that processes a first packet unit and a consecutive second packet unit, the decoding device comprising:
a bit stream feeder that provides the first packet unit and the second packet unit, determines a boundary of the first packet unit, and transmits a first boundary informing signal;
a decoder, coupled to the bit stream feeder, that decodes the first packet unit and the second packet unit, determines the boundary of the first packet unit, and transmits a second boundary informing signal; and
a determining circuit, coupled to the bit stream feeder and the decoder, that receives the first boundary informing signal and the second boundary informing signal, and generates a determination result signal according to the first boundary informing signal and the second boundary informing signal, the decoder and the bit stream feeder operating according to the determination result signal to decode the second packet unit when the first packet unit cannot be successfully decoded.

2. The decoding device as claimed in claim 1, wherein the first packet unit comprises a plurality of first bit data and the second packet unit comprises a plurality of second bit data, and wherein when the bit stream feeder detects according to the determination result signal that the bit stream feeder determines the boundary of the first packet unit before the decoder does, the bit stream feeder provides at least one dummy bit to the decoder upon a bit data request from the decoder, so that the decoder decodes the second packet unit according to the plurality of second bit data.

3. The decoding device as claimed in claim 1, wherein the first packet unit comprises a plurality of first bit data and the second packet unit comprises a plurality of second bit data, and wherein when the decoder detects according to the determination result signal that the decoder determines the boundary of the first packet unit before the bit stream feeder does, the decoder discards a part of the plurality of first bit data provided by the bit stream feeder, so that the decoder decodes the second packet unit according to the plurality of second bit data.

4. The decoding device as claimed in claim 1, wherein the first packet unit comprises a plurality of first bit data and the second packet unit comprises a plurality of second bit data, and wherein the bit stream feeder or the decoder determines the boundary of the first packet unit according to a predetermined format formed by at least one of the plurality of first bit data.

5. The decoding device as claimed in claim 1, wherein the bit stream feeder or the decoder determines the boundary of the first packet unit according to a start code prefix of the second packet unit or an end identification bit group of the first packet unit.

6. The decoding device as claimed in claim 1, wherein the decoder determines the boundary of the first packet unit according to at least one syntax data of the first packet unit.

7. The decoding device as claimed in claim 1, the decoding device respectively defines a parity for the first packet unit and a parity for the second packet unit.

8. The decoding device as claimed in claim 7, wherein a logical value of the parity of the first packet unit is different from a logical value of the parity of the second packet unit.

9. The decoding device as claimed in claim 8, wherein the determining circuit comprises:
a first register that stores a first register value representing a parity of a current packet unit processed by the bit stream feeder;
a second register that stores a second register value representing a parity of a current packet unit processed by the decoder;
a first logic unit that selectively alters the first register value according to the first boundary informing signal;
a second logic unit that selectively alters the second register value according to the second boundary informing signal; and
a third logic unit that generates the determination result signal according to the first register value and the second register value.

10. The decoding device as claimed in claim 9, wherein the third logic unit comprises an XNOR gate coupled to the first register and the second register.

11. A decoding method for processing a first packet unit and a consecutive second packet unit, the decoding method comprising:
a) without decoding the first packet unit, determining a boundary of the first packet unit to transmit a first boundary informing signal;
b) requesting for bit data to decode the first packet unit and determine the boundary of the first packet unit to transmit a second boundary informing signal;
c) generating a determination result signal according to the first boundary informing signal and the second boundary informing signal; and
d) decoding the second packet unit according to the determination result signal when the first packet unit cannot be successfully decoded.

12. The decoding method as claimed in claim 11, wherein the first packet unit comprises a plurality of first bit data and the second packet unit comprises a plurality of second bit data, and wherein the step (d) further comprises:
when the step (a) determines the boundary of the first packet unit before the step (b), and when the step (b) requests for bit data, providing at least one dummy bit to decode the second packet unit according to the plurality of the second bit data.

13. The decoding method as claimed in claim 11, wherein the first packet unit comprises a plurality of first bit data and the second packet unit comprises a plurality of second bit data, and wherein the step (d) comprises:
when the step (b) determines the boundary of the first packet unit before the step (a), discarding a part of the plurality of the first bit data to decode the second packet unit according to the plurality of second bit data.

14. The decoding method as claimed in claim 11, wherein the first packet unit comprises a plurality of first bit data and the second packet unit comprises a plurality of second bit data, and wherein the step (a) or the step (b) comprises:
determining the boundary of the first packet unit according to a predetermined format formed by at least one of the plurality of first bit data of the first packet unit.

15. The decoding method as claimed in claim 11, wherein the step (a) or the step (b) comprises:
determining the boundary of the first packet unit according to a start code prefix of the second packet unit or an end identification bit group of the first packet unit.

16. The decoding method as claimed in claim 11, wherein in the step (b), the boundary of the first packet unit is determined according to at least one syntax data of the first packet unit.

17. The decoding method as claimed in claim 11, further comprising:
e) respectively defining a parity for the first packet unit and the second packet unit, wherein a logical value of the parity of the first packet unit is different from a logical value of the parity of the second packet unit.

18. The decoding method as claimed in claim 17, wherein the step (c) further comprises:
detecting a currently processed packet unit in the step (a) and a currently processed packet unit in the step (b) respectively according to the first boundary informing signal and the second boundary informing signal; and
determining whether the parities of the currently processed packet unit in the step (a) and the currently processed packet unit in the step (b) are of a same logical value to generate the determination result signal.
